(19) United States
(12) Patent Application Publication
(10) Pub. No.: US 2004/0159330 A1
(43) Pub. Date: Aug. 19, 2004

(54) Brush sanitizer

(76) Inventors: Paul Anemone, Morganville, NJ (US); Kristine Anemone, Morganville, NJ (US)

Correspondence Address: Mr. Walter J. Tencza Jr., Suite 3, 10 Station Place, Metuchen, NJ, 08840, US

(21) Appl. No.: 10/367,544

(22) Filed: Feb. 14, 2003

(51) Int. Cl. B08B 3/12

(52) U.S. Cl. 134/1; 134/26; 134/42; 250/455.11; 422/300

(57) ABSTRACT

A toilet brush holder is disclosed, which automatically stores, cleans, and sanitizes a toilet brush. The toilet brush holder may include a reservoir or pool of sanitizing liquid in which the toilet brush can reside. The toilet brush holder may include a door for accessing the toilet brush.

### FIELD OF THE INVENTION

This invention relates to improved methods and apparatus concerning sanitizing toilet brushes.

### BACKGROUND OF THE INVENTION

After a toilet brush has been used to clean a toilet, one must typically immediately clean the toilet brush to keep it in a sanitary condition. Cleaning toilet brushes is messy and inconvenient.

### SUMMARY OF THE INVENTION

The present invention in one or more embodiments provides an apparatus which stores, cleans and sanitizes a toilet brush. The apparatus may be comprised of a device or toilet brush holder that typically operates on batteries. The apparatus may further include a built-in, light which may be florescent and will typically kill any bacteria, germs, etc. that are present. A spring mechanism may be provided in one embodiment. When a toilet brush is put back into the holder, the spring mechanism may rise, thereby lifting the brush out of the solution and triggering a light to go on for a time period. The apparatus may be comprised of a typical known toilet brush which may be eighteen inches long. The toilet brush holder typically secures the handle of the toilet brush in place. The toilet brush holder may also feature a spring to hold the toilet brush in place and let the excess liquid drip off the bristles after each use of the toilet brush. The toilet brush holder may include a base which may contain a pool of sanitizing fluid.

In operation, an individual may simply insert the toilet brush into the device or toilet brush holder and secure the toilet brush in place by the handle of the toilet brush. One or more bristles of the toilet brush can be cleaned by pushing it downwards into a pool of cleaning liquid and the toilet brush bristles may be automatically cleaned by sitting in the cleaning solution. The apparatus may measure twenty four inches in length from the top of the toilet brush to the bottom of the toilet brush holder when the toilet brush is in the upright position with the spring extended, i.e. the toilet brush bristles not in the sanitizing or cleaning solution. The toilet brush holder may have a cylindrical base portion which may have a diameter of six inches. The toilet brush holder could be produced from hard plastic and in a wide range of colors and styles to coordinate with any bathroom decor. The bristles could be formed from nylon.

The toilet brush holder or device would automatically scrub away dirty water from the bristles of the toilet brush while allowing the toilet brush to soak in a reservoir of cleaning solution. By using the present invention in one or more embodiments, users would have peace of mind knowing that a clean and sanitary brush would be used each and every time. The toilet brush holder would also allow a homeowner to use space more efficiently, especially in smaller bathrooms, by storing a toilet bowl brush in an attractive and decorative toilet brush holder instead of in a closet or storage cabinet. The present invention in one or more embodiments would be functional, practical, handy, durable, and an affordable and would also store the brush in a hygienic environment, since it would be enclosed.

### BRIEF DESCRIPTION OF THE DRAWINGS

FIG. 1 shows an apparatus including a toilet brush and a toilet brush holder in accordance with a first embodiment of the present invention, wherein a door of the toilet brush holder is in a closed state and a spring of the toilet brush holder is in an expanded state;

FIG. 2 shows the toilet brush holder of FIG. 1 in the same state as in FIG. 1, however, the toilet brush holder in FIG. 2 is shown without the toilet brush;

FIG. 3 shows the toilet brush holder of FIG. 1, however in FIG. 3 the door is in an open state and the spring is in a compressed state;

FIG. 4 shows the toilet brush holder and the toilet brush of FIG. 1, however in FIG. 4, the spring of the toilet brush holder is in a compressed state and the door of the toilet brush holder is in a closed state; and

FIG. 5 shows the toilet brush holder and the toilet brush of FIG. 1, however in FIG. 5, the door of the toilet brush holder is shown in an open state, the spring of the toilet brush holder is shown in a compressed state, and the toilet brush is shown in an angled or slanted position.

### DETAILED DESCRIPTION OF THE DRAWINGS

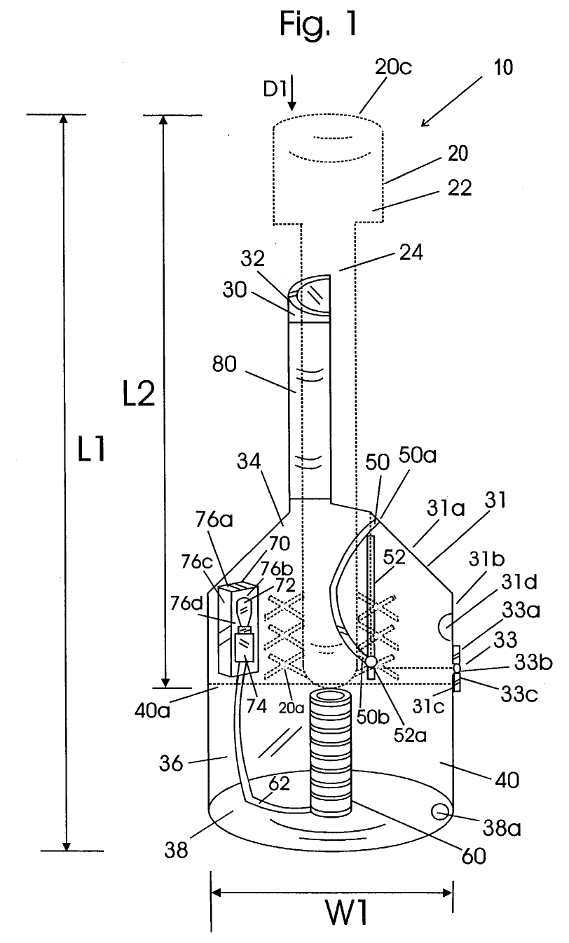

FIG. 1 shows an apparatus 10 including a toilet brush 20 and a toilet brush holder 30 in accordance with a first embodiment of the present invention. The toilet brush 20 is shown in dashed lines. The toilet brush holder 30 may be substantially in the form of a bottle with one side missing to allow the toilet brush 20 to be placed into and removed from the toilet brush holder 30.

The toilet brush holder 30 may include a neck portion 32, which may be in the shape of half of a cylinder to allow for insertion and removal of the toilet brush 20. The toilet brush holder may include an inclined portion 34, a cylindrical body portion 36, and a base portion 38. The cylindrical body portion 36 and the base portion 38 together form a receptacle which can retain a liquid such as a sanitizing solution 40 whose level is shown by dashed line 40a. The sanitizing solution may be any type of sanitizing or cleaning solution known in the art.

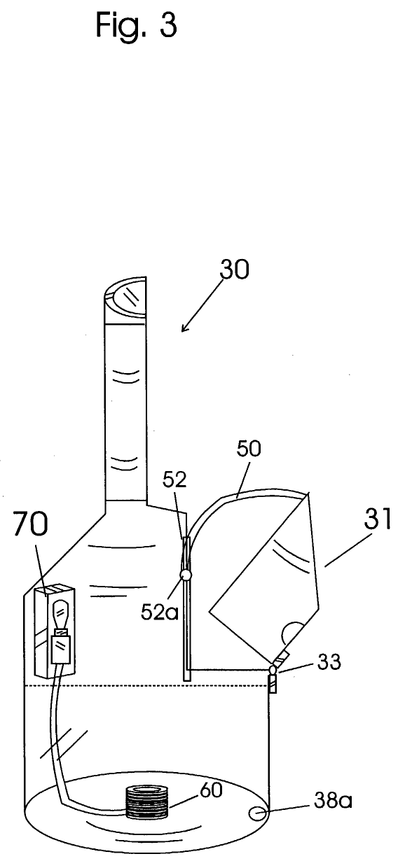

The toilet brush holder 30 may include a door 31. The door 31, along with the opening in neck portion 32, allows for removal of the toilet brush 20 from the toilet brush holder 30. The door 31 may include portion 31a which may be part of inclined portion 34 and portion 31b which may be part of cylindrical body portion 36. The door 31 may be connected to a hinge 33. The hinge 33 may include portions 33a, 33b, and 33c. The portion 33a of the hinge 33 may be connected to the portion 31b. The portion 33b of the hinge may be connected to the portion 31c. Portion 31b of the door 31 may include a window 31d. The window 31d may allow an individual to see into the toilet brush holder 30 and to see the light 74 turn on and off. The window 31d may be a transparent glass or plastic which is comprised of or includes an ultraviolet protective covering. The solution level 40a of the solution 40 can be viewed when the door 31 is in the open state FIG. 3.

The portion 31a of the door 31 may be connected to an end 50a of a bracket 50. An end 50b of the bracket 50 may be connected to a pin 52a which may slide up and down within a channel or rail 52. The channel or rail 52 may be fixed to the portions 34 and 36, so that when the door 31 is opened, as in FIG. 3, the channel or rail 52 does not change position.

Within the toilet brush holder 30, is a spring 60. The spring 60 may be fixed to the base 38. The spring 60 may include an electrical switch. The electrical switch of the spring 60 may be electrically connected through a wire 62 to a lighting device 70. The lighting device 70 may include a power source 74 and a light 72. The lighting device 70 may also include or be housed by a protective hood 76. The protective hood 76 may include a reflective side 76a, a reflective side 76b, a reflective side 76c, and a transparent front 76d. The lighting device 70 may be a germicidal light which may kill germs or bacteria. The protective hood 76 can be mounted to the portion 34 or 36 of the toilet brush holder 30. The lighting device 70 would typically be above the level 40a of the sanitizing solution 40. A drainage plug 38a may be provided in the base 38. The drainage plug 38a may be removed to provide a drainage hole in the base 38 for draining sanitizing solution 40 out of the toilet brush holder 30.

The toilet brush holder 30 may also be provided with a clasp or clamp 80 which can hold the toilet brush 20 in an upright position as in FIG. 1. The toilet brush 20 may be comprised of bristles 20a. The bristles are shown out of the solution 40 and above the solution level 40a in FIG. 1.

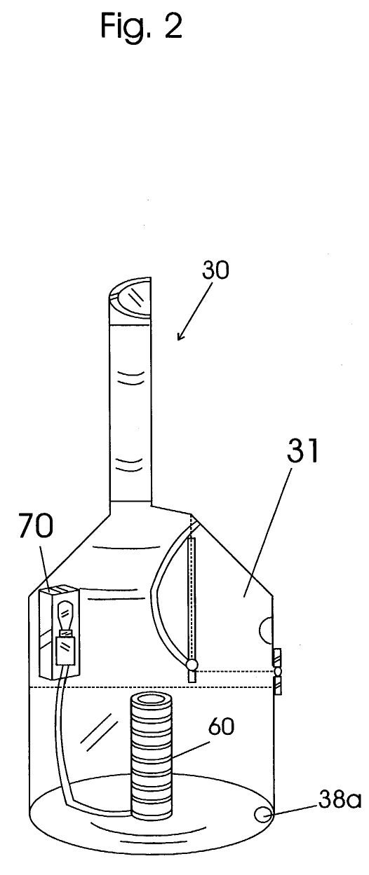

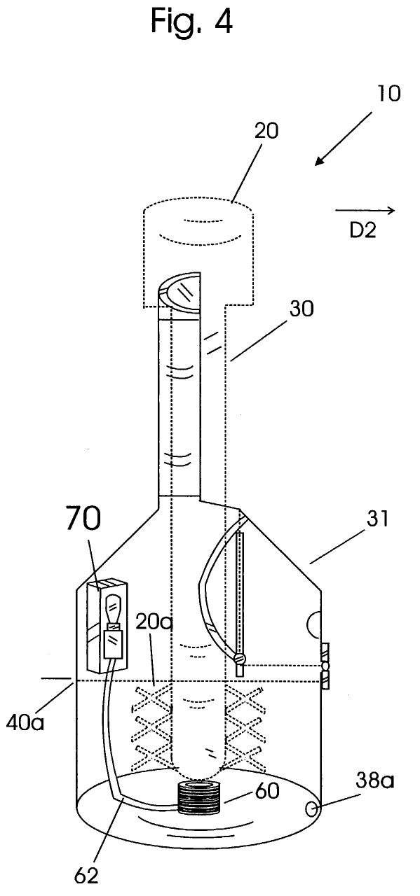

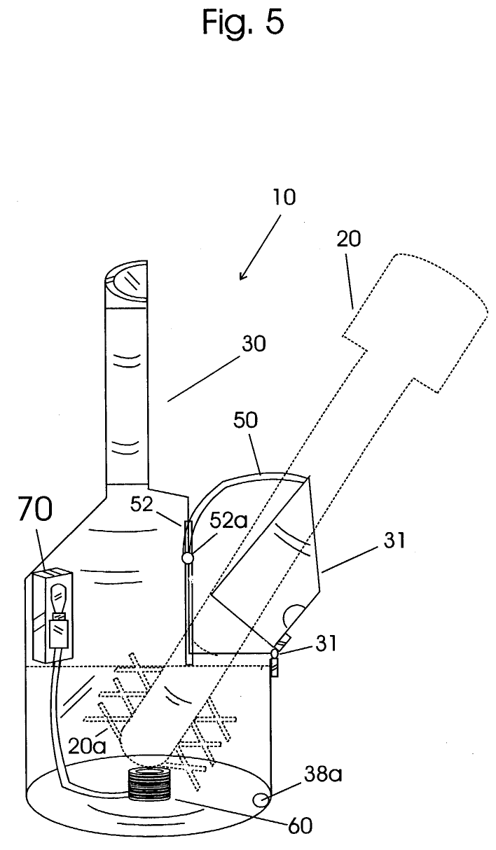

FIG. 2 shows the toilet brush holder 30 of FIG. 1 in the same state as in FIG. 1, however, the toilet brush holder 30 in FIG. 2 is shown without the toilet brush 20. FIG. 3 shows the toilet brush holder 30 of FIG. 1, however in FIG. 3 the door 31 is in an open state and the spring 60 is in a compressed state. FIG. 4 shows the toilet brush holder 30 and the toilet brush 20 of FIG. 1, however in FIG. 4, the spring 60 of the toilet brush holder 30 is in a compressed state and the door 31 of the toilet brush holder 30 is in a closed state. FIG. 5 shows the toilet brush holder 30 and the toilet brush 20 of FIG. 1, however in FIG. 5, the door 31 of the toilet brush holder 30 is shown in an open state, the spring 60 of the toilet brush holder 30 is shown in a compressed state, and the toilet brush 20 is shown in an angled or slanted position.

In operation, the toilet brush 20 and the toilet brush holder 30 may be placed in a state such as shown in FIG. 1. If an individual wants to clean the toilet brush 20, the individual would press downwards on the toilet brush 20 in the direction D1, shown by FIG. 1. Pressing downwards on the toilet brush 20 in the direction D1 causes the toilet brush 20 to press against the spring 60. As a result the spring 60 compresses until it reaches the state shown in FIG. 4. When the spring 60 reaches the position or state shown in FIG. 4, the downward force on brush 20 may be removed. The spring 60 may be or may include a toggle switch which allows the spring 60 to remain in the compressed state shown in FIG. 4 without continuously apply downward force in the direction D1. In the state or position of FIG. 4, the bristles 20a are below the level 40a of the sanitizing solution 40. The bristles 20a are in the sanitizing solution in FIG. 4 and the sanitizing solution cleans the bristles 20a.

When the spring 60 changes from the state of FIG. 4 to the state of FIG. 1, the spring 60 sends a signal or connects a circuit to the lighting device 70. This causes the lighting device 70 and the light 72 to turn on. The light 72 emits light which kills germs and bacteria. An individual can leave the brush 20 in the state of FIG. 1 for as long as the individual desires.

When an individual decides to take the toilet brush 20 out of the toilet brush holder 30, the individual would pull the brush 20 in the direction D2 shown in FIG. 4. This causes the brush to tilt and the spring to compress downwards as shown in FIG. 5 and also causes the door 31 to open. The door 31 pulls on the bracket 50 which pulls on the pin 52a, which slides in the channel 52 to the position shown in FIG. 5. an individual can then take the brush 20 out of the brush holder 30. The brush 20 can be placed back in the holder 30 by placing the brush 20 into an upright position, as in FIG. 1, and closing the door 31.

The brush 20 can be taken out of the solution by simply pressing downwards in the direction D1. The spring 60 can be a toggle switch, which when pressed for a second time releases from the compressed state of FIG. 4 and returns to the expanded state of FIG. 1. The change of the spring 60 from the compressed state of FIG. 4 back to the expanded state of FIG. 1 may also cause the lighting device 70 to turn on for a period of time. As shown in FIG. 1, the bristles 20a would now be above the level 40a and thus out of the sanitizing liquid 40

The power source 74 may be comprised of two “D” batteries which may power the lighting device 70 and the light 72 and a timing device to turn the light off after a period of time. The light 72 may be a one hundred twenty volt, three watts light bulb or lamp. The light 72 may be a germicidal lamp having a light center length of 40 millimeters, having a base type of intermediate, having a lamp type of incandescent, having a rated life of 2000 hours, and having a maximum length of sixty-three millimeters.

The clasp or clamp 80 may be a plastic clasp and may be attached to the toilet brush holder 30 as shown by FIG. 1. The clasp 80 may hold the toilet brush 20 may be able to slide upwards or downwards, depending on the position of the spring 60. The brush 20 may be a typical toilet brush known in the art, and may be comprised of handle portion 22, and a tube portion 24. The tube portion 24 may have criss cross bristles 20a near an end 20b of the brush 20.

The length, L1, from a top 20c of the brush 20 to the bottom of base 38 of the toilet brush holder 30 may be twenty-four inches, when the spring 60 is in the expanded state of FIG. 1. The width W1 of the base portion 38 may be six inches. The length, L2 of the toilet brush 20 may be eighteen inches.

When an individual wants to add solution to the toilet brush holder 30, typically the individual would open the door 31, remove the brush 20, and pour in the appropriate amount of sanitizing solution through the door 31. The level 40a shown in FIG. 1, may be defined by a marking or line on the toilet brush holder 30 which specifies how much solution 40 should be placed into the toilet brush holder 30.

The lighting device 70 may automatically turn on the light 72 when the spring mechanism 60 is pressed by the brush FIG. 4 and the door 31 closes for a certain length of time. The door 31 may include a switch or circuit which may be electrically connected to the lighting device 70 and which may cause the light 72 to be turned on for a certain period of time after the door 31 closes and the spring compresses to the upwards state FIG. 1.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a toilet brush holder;
wherein the toilet brush holder automatically cleans a toilet brush.

2. The apparatus of claim 1 wherein
the toilet brush holder includes a light.

3. The apparatus of claim 2 wherein
the light provides a germ, and bacteria free environment.

4. The apparatus of claim 1 wherein
the toilet brush holder included a reservoir which includes a sanitizing liquid.

5. The apparatus of claim 1 wherein
the toilet brush holder includes a door which allows access to the toilet brush.

6. A method comprising the steps of:
Inserting a toilet brush into a toilet brush holder; and
cleaning a toilet brush while the toilet brush is in the toilet brush holder.

7. The method of claim 6 further comprising
activating a light to kill a substantial amount of bacteria and germs.

8. The method of claim 6 wherein
the toilet brush holder includes a reservoir which includes a sanitizing liquid.

9. The method of claim 6 wherein
the toilet brush holder includes a door which allows access to the toilet brush.
